(19) United States
(12) Patent Application Publication
(10) Pub. No.: US 2023/0038002 A1
(43) Pub. Date: Feb. 9, 2023

(54) SOLAR POWERED SHELTER FOR PRODUCING AND STORING ENERGY AND/OR WATER

(71) Applicant: Pulse Grids, LLC, New York, NY (US)

(72) Inventor: Todd DE LUCA, New York, NY (US)

(21) Appl. No.: 17/758,708

(22) PCT Filed: Jan. 14, 2021
(86) PCT No.: PCT/US2021/013361

§ 371 Date: Jul. 13, 2022

Related U.S. Application Data
(60) Provisional application No. 62/961,123, filed on Jan. 14, 2020.

(51) Int. Cl. E04H 1/12; H02S 20/23

(52) U.S. Cl. CPC E04H 1/1205; H02S 20/23; E04H 9/14

(57) ABSTRACT

The present disclosure is directed to a solar-powered shelter for producing and storing electrical power and/or water; the shelter comprises a roof (1) arranged with one or more photovoltaic modules (4) and/or one or more devices (17) for dehumidifying ambient air, and a structure (8,9) arranged underneath the roof.

This application claims priority to U.S. Provisional Application No. 62/961,123, filed Jan. 14, 2020, the contents of which are incorporated by reference herein in their entirety.

The present disclosure relates generally to an energy dense solar powered shelter for producing energy and/or water that is configured for supporting a variety of structures, such as container units. The structures are configured for providing different living necessities such as, but not limited to, temperature and/or humidity-controlled shelter, refrigerated food storage, kitchens, toilets, workspaces, bathing areas, medical stations, aquaponic systems, hydroponic systems, electric vehicle parking and charging station, communication hubs and operational command centers, equipment bays, and critical equipment storage. For example, the shelter is suitable for decentralized use, such as installation in rural areas, in regions with undeveloped infrastructure, or on mobile man-made platforms such as barges or other floating platforms. The pre-packaged and rapidly deployable nature of the shelter, along with its self-sufficiency and capability to withstand severe weather forces make the shelter deployable in areas that require immediate, self-sustaining shelters for people and communities, animals and livestock, and critical equipment sensitive to the external environment.

Climate change as well as an increasing human population pose a growing challenge for the provision of energy, clean drinking water, and service water for additional utilities such as plumbing, laundry, and agriculture. This is especially true for undeveloped countries and regions with minimal infrastructures, which lack the investment capability or natural resources to rapidly develop solutions to overcome those challenges.

In areas of human conflict, the ability to install and operate critical infrastructure is a challenge due to investment considerations and the need for liquid logistics associated with the use of fossil fuel power generation methods and the need to supply water. Conventional fossil fuel generation systems, e.g., diesel generators, produce environmental pollutants while in use and require a continuous supply of liquid fuel to operate, which in turn creates more environmental pollution under transport. Reductions in the logistical demands for energy and water therefore serve to increase operational effectiveness in conflict zones and/or remote locations while further mitigating certain warfighting risks.

Furthermore, regions that are susceptible to a natural disaster, such as an earthquake, hurricane, tornado, fires, or the like, may require shelter during the period in which rebuilding is taking place. Other regions, such as those in conflict zones, may require shelter and critical infrastructure to support combat effectiveness and capability. Available conventional shelters may be difficult to transport, difficult to set-up, susceptible to follow-up natural forces such as aftershocks and thunderstorms and may be limited in its size shape and features. In natural disaster scenarios, for example the shelter is needed quickly and should be easy to assemble. The unit also needs to be capable of providing the basic necessities in order to sustain or support life, including, but not limited to, food, water, and power.

Current systems for temperature-controlled living environments and liquid treatments for a decentralized use present potential drawbacks. For example, current self-sufficient and compact systems include at least one evaporation chamber for raw water or wastewater, condensation chambers for the gas produced during evaporation, a cold storage unit, and an energy conversion unit. The system functions via the utilization of gas which is passed through a heat exchanger in front of the condensation chamber. Ice is then formed in the evaporation chamber that can be stored for refrigeration purposes. The system, however, does not include solutions for providing drinking water to an external building or for temperature control of an external building with low energy supply. Furthermore, the equipment and installation costs are comparatively high to the current claimed disclosure.

Additionally, there are multiple self-sustaining known water treatment systems. For example, current water treatment systems include a coupled drinking water tank that uses solar power as an energy source. The treatment system is also capable of collecting rainwater which is passed through the water processing plant to be cleaned and filtered into the drinking water tank.

Other systems feature a self-sufficient water extraction system that pulls water from the surrounding air humidity without any additional power. Ambient air is heated throughout the day and cooled at night in a condenser. The cooled air flow can be throttled depending on the temperature and heated after the condensation process by means of counterflow with the supplied air.

A further system features a condenser for dehumidifying with at least one electrically driven rotor made of open-cell metal foam. The condenser includes a plurality of cooling elements which are connected to the rotor blades. In operation, the rotating rotor blades are cooled to a temperature of 3-5 degrees below the ambient temperature. The moisture contained in the flowing air then condenses on the cooled rotor blades and then is thrown onto the inner housing wall before running into a water-collecting container.

There are problems with these currently existing solutions. For example, because of the low water extraction rate present in these systems, the systems are suitable only for individual household applications and are incapable of servicing many people at once. Additionally, the solutions only provide water and/or energy, and are not integrated into a larger system that can provide for a variety of other needs essential to human survival such as food storage, medical stations, bathing areas, and toilet facilities.

The present disclosure seeks to solve one or more of those problems by developing a solar-powered shelter configured for self-producing enough energy and/or water to support a variety of different shelters or container units that are configured for providing a variety of services necessary to support human survival such as, but not limited to, shelter, food storage, bathing areas, medical stations, workspaces, toilets, and any combinations thereof. With the shelter, the living costs and carbon footprint of people, such as those present in areas of undeveloped infrastructure, can be reduced.

In aspects of the present disclosure, the disclosure is directed to a solar-powered shelter for producing and storing electrical power and/or water comprising: a roof arranged with one or more photovoltaic modules and/or one or more devices for dehumidifying ambient air; and a structure arranged underneath the roof.

In other aspects of the disclosure, the structure forms a room chosen from a temperature-controlled shelter, an electrical power distribution and generation center, a bathing area, a bathroom area, systems for purifying and storing water, a temperature-controlled food storage, a hospital for medical consultation and treatment, a kitchen, a workspace, a storage facility, an office space, a consultation space, and combinations thereof. Further, in yet additional aspects, the structure is made from a material chosen from metal, fiberglass, polyethylene, and combinations thereof. In further aspects, the shelters are sized to conform with intermodal container standards. Additionally, in further aspects, the one or more shelters are formed adjacent to each other to form a microgrid.

In aspects of the disclosure, the shelter is configured for withstanding natural or artificial disasters chosen from Category 5 hurricanes, tornadoes, earthquakes, vertical flooding float, electrical magnetic pulses, and combinations thereof. Additional aspects include wherein the shelter self-produces a usable quantity of electricity per day per person.

In some aspects, the roof is configured into an arch formation and each end of the roof extends until reaching a foundation. Additionally, the roof comprises a framework of plug-in, connectable elements. For example, the connectable elements are metal. Further for example, the roof is in a form of single-tube or double-tube construction, depending on the need to conform to local building or zoning codes, if any.

In further aspects, the foundation is chosen from soil, sand, clay, rocks, man-made platforms, earth from a hurricane, a tornado, or a fire, and combinations thereof.

In additional aspects, the one or more photovoltaic modules fully cover a top portion of the roof except for a central aisle on a roof ridge. In further aspects, the roof ridge comprises one or more fans configured for intaking ambient air.

In yet further aspects, the one or more photovoltaic modules may be single-direction or bi-directional photovoltaic modules which are aligned on a longitudinal axis on the roof. In additional aspects, the structure is coated in a paint chosen from high albedo paints, paints with reflective glass beads, and combinations thereof. Further, the structure is constructed of painted or galvanized steel or equivalent materials, such as aluminum or composite materials.

Additionally, in some aspects, the roof, the one or more photovoltaic modules, or combinations thereof are aligned at an optimized angle in order to maximize energy capture efficiency. For example, the optimized module angle ranges from about 35 degrees at the foundation of the arch to about 2.5 degrees at the apex of the arch, with the angles of certain modules moving upwards from the foundation to the apex decreasing by 5 to 2.5 degrees to ensure maximal solar energy capture.

In additional aspects, the structure connects to the roof through one or more brackets under the roof and in alignment to the roof.

In yet further aspects, the structure further comprises a charge controller, direct current to alternating current power inverter, batteries, and shelves for charged and uncharged batteries. For example, the structure comprises power equipment configured for charging electric vehicles.

In additional aspects, the structure further comprises one or more water generators for separating humidity and associated water reservoirs from the ambient air intake.

In some aspects, the structure further comprises one or more toilets for human waste disposal. In further aspects, the structure further comprises bathing stalls configured for providing hot and ambient water for human use. In additional aspects, the structure further comprises one or more water storage tanks for storing up to at least 6,000 liters. Further, in some aspects, the structure further comprises equipment necessary for aquaponic systems, such as for indoor growth of fish and other aquatic life. In some aspects, the structure further comprises equipment necessary for hydroponic usage and systems, such as for indoor growth of plants and organic vegetables. Additionally, the structure further comprises equipment necessary for the sheltering of animals and/or livestock.

In some aspects, the structure is configured as a temperature-controlled room. For example, the room is configured for housing people, and providing internet connectivity and charging stations. Further for example, the structure is a temperature-controlled storage area for cold storage of food and liquids. Additionally, for example, the room comprises medical equipment and devices with one or more electrical power supplies to serve as a hospital. In some aspects, the room comprises cooking equipment to serve as a kitchen. For example, the cooking equipment is chosen from stoves, ovens, fryers, microwaves, and combinations thereof with one or more electrical power supplies. In further aspects, the room comprises one or more shelves and other furniture configured for storage.

In some aspects, the present disclosure is directed to a solar-powered shelter for producing and storing electrical power and/or water comprising: a roof arranged with one or more photovoltaic modules and/or one or more devices for dehumidifying ambient air. In further aspects, the roof is supported by lightweight supports and vertical stanchions, and the roof is attached to a foundation through the use of micropiles.

### BRIEF DESCRIPTION OF DRAWING(S)

FIG. 1 shows a cross-section along a horizontal plane of an embodiment of the shelter.

FIG. 2 shows an embodiment of the shelter according to the disclosure in FIG. 1 in a first partial section.

FIG. 3 shows an embodiment of the shelter according to the disclosure in FIG. 1 in a second partial section

FIG. 4 shows an embodiment of the shelter according to the disclosure along a longitudinal plane.

FIG. 5 shows an embodiment of the roof construction in an embodiment of the disclosure.

FIG. 6 shows the optimized angles at which the roof is titled in order to absorb the maximum amount of sunlight throughout the different hours of the day as the sun moves across the sky.

FIG. 7 shows a cross-section of the present disclosure in a microgrid configuration.

FIGS. 8 to 19 show embodiments of the present disclosure with structures having various different functions. That is, FIG. 8 illustrates a structure configured for power production; FIGS. 9A and 9B illustrate a structure configured for sheltering or housing people; FIGS. 10A and 10B illustrate a structure configured for bathroom facilities with one or more toilets, showers, and sinks; FIGS. 11A and 11B illustrate a structure configured for water generation and purification; FIG. 12 illustrates a structure configured for water storage; FIGS. 13A and 13B illustrate a structure configured for refrigeration and storage of perishable food; FIGS. 14A and 14B illustrate a structure configured for storage of various items; FIGS. 15A and 15B illustrate a structure configured for use as a hospital for medical consultation and treatment; FIGS. 16A and 16B illustrate a structure configured for use as a kitchen; FIGS. 17A and 17B illustrate a structure configured for use as office space; FIG. 18 illustrates a shelter configured for use as a space for hydroponic plant and organic vegetable growing; FIG. 19 illustrates a shelter configured for aquaponic usage.

FIG. 20 illustrates a microgrid comprised of numerous shelters that is connected to an adjoining microgrid comprised of numerous shelters by using shelters to provide protected passageways. One or more microgrids may be connected to allow people to move within the microgrid's various shelters without interacting with the outside environment.

FIG. 21 illustrates a shelter including the roof and lightweight supports and vertical stanchions to support the photovoltaic modules on the roof.

### DESCRIPTION

As used herein, “a” or “an” entity refers to one or more of that entity. As such, the terms “a” (or “an”), “one or more”, and “at least one” are used interchangeably herein.

As used herein, the term “about” or “approximately” means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 5%.

Shelter

In some embodiments, the shelter of the present disclosure is pre-packaged and rapidly deployable, and constructed in areas with undeveloped infrastructure or minimal financial support, or in areas of human conflict where critical infrastructure is needed to support operational effectiveness. Each shelter is configured as a standalone shelter or configured to be built alongside one another, forming a microgrid of a variety of the same or different functional structures depending on the needs of the community or shelter use requirements.

For example, in some embodiments, the shelter can be used as a standalone unit. That is, the shelter is configured for generating its own power and/or water. Where one or more shelters are needed and deployed, each shelter can be configured to be interconnected provided that the connection does not interfere with the energy and/or water production functions of each shelter. For example, when considering that each shelter can be a standalone structure, interconnection or proximity between shelters can be dependent upon, but not limited to, the following considerations: 1) the prevention of creating any orientation that would limit photovoltaic exposure to any portion of the roof structure; and/or that would 2) create any efficiency loss of either energy or water that would be shared between the two shelters, e.g., changes in elevation, distance, or depending on the external environment, temperature.

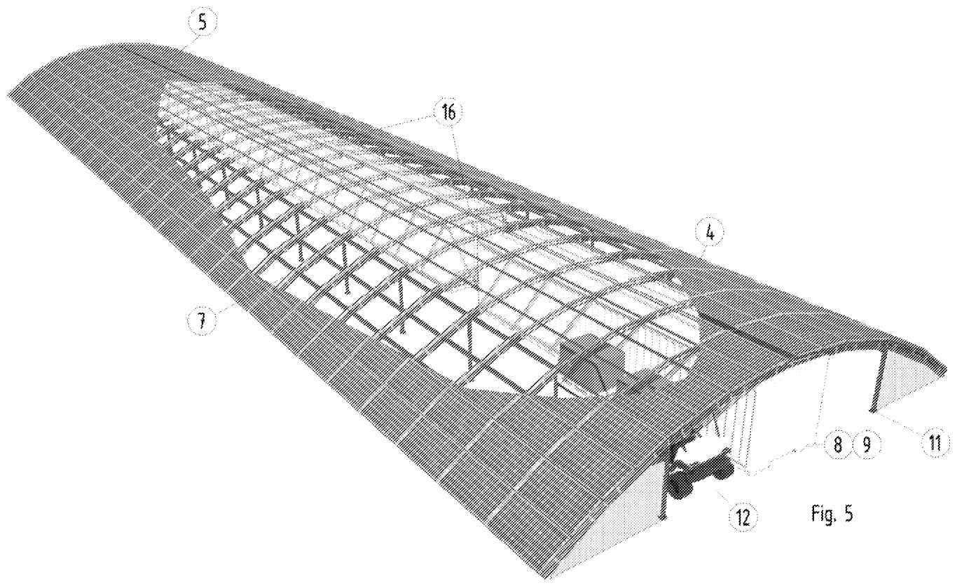

In some embodiments, in a community, shelters are joined to or interconnected to one another through the use of brackets (e.g., metal brackets or equivalents thereof), which secures one structure/container to another, while simultaneously helping to provide alignment guidances when deploying. Additionally, in some embodiments, the shelters can merely be placed next to one another. In either instance, two or more shelters form a microgrid, as illustrated in FIGS. 5, 7, and 20. A microgrid of shelters may include a variety of the same or different functional shelters depending on the needs of the community or shelter use. For example, the shelters of a microgrid may include functions for a temperature-controlled shelter, an electrical power distribution and battery storage center, a bathing area, a bathroom area, systems for purifying and/or storing water (for drinking, bathing, and agriculture, including livestock, purposes), a temperature-controlled food storage, hospital for medical consultation and treatment, a kitchen, a workspace, a storage facility, an office space, a consultation space, dedicated aquaponic systems, hydroponic systems capable of producing organic produce, electric vehicle parking and charging, and combinations thereof. Alternatively, in a community that requires medical aid, medical station and power control units can be added to the microgrid to provide the community with access to medical devices as well as the usable energy to power said devices. Given the flexible nature of the presently disclosed shelters and microgrids, they can be used to house any number of people, animals, or pieces of equipment for short term or long term. For example, the combination of the shelters enable a flexible approach to serve people ranging from 1 or 2 people to a whole community of people of 100, 200, 300, 400, 500, 1,000, or more.

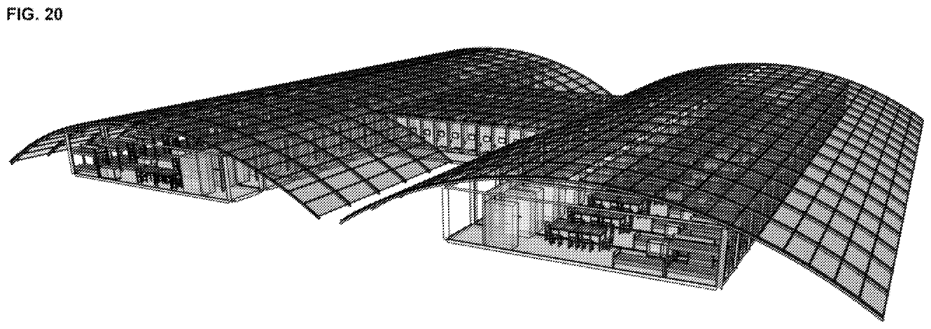

In some embodiments, one or more microgrids may be connected to allow people to move within the microgrid's various shelters without interacting with the outside environment, as illustrated in FIG. 20. For example, microgrids may be connected by means of using shelters with integrated vestibules or shelters that serve solely as a vestibule.

The shelters of the present disclosure generate power solely by solar energy, which provides usable power directly to devices within the shelter or microgrid that require electricity, charges batteries within the shelter or microgrid to ensure continued use of electrical devices, or any combination thereof. In some embodiments, the shelters can include other equipment designed to also provide usable power to external sources, e.g., the shelters may include power inverters that send photovoltaic power produced by solar energy and/or stored in batteries to an external power grid designed to accept energy from various power generation sources. For example, the shelter can function either in conjunction with additional equipment and constructions or completely decentralized and “off-the-grid.”

In some embodiments, the shelter is also designed to withstand natural and artificial disasters such as hurricanes, tornadoes, earthquakes, flooding, and/or electrical magnetic pulses. For example, the shelter can withstand up to Category 5 hurricane winds or tornado force winds by using, e.g., one or more steel shipping containers for structural support, steel brackets and fasteners for securing the roof to the structure, steel framing and photovoltaic panels that comprise the roof, and cement piles used to secure the framing to the ground. In some further embodiments, the shelter can withstand earthquakes by using one or more steel shipping containers for structural support, steel brackets and fasteners for securing the roof to the structure, steel or aluminum, polyethylene, or composite framing and photovoltaic panels that comprise the roof, and cement piles or micropiles used to secure the framing to the ground. In some embodiments, the shelter can withstand vertical float during flooding by mounting the shelter structure upon support piles which elevate the shelter from flooding hazard. In some embodiments, the shelter can withstand electrical magnetic pulses by generating power from solar energy using a low voltage direct current power supply and delivery system, surge protection relays and switchgear, shielded power cables, and by utilizing the shelter's structural and framing components as grounding.

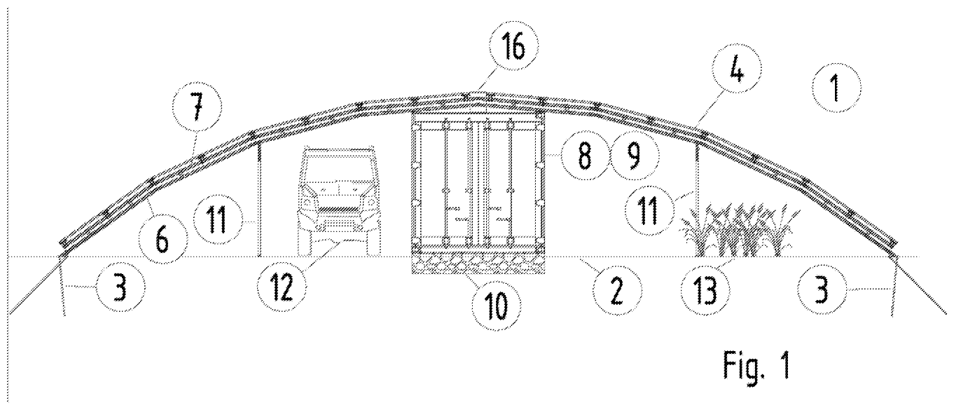

The shelter comprises a roof 1, which can be arched and/or can sit on top of a double or single pipe construction that is supported by structures or containers 8 and 9, as exemplified in FIG. 1. The shelter can generate electrical power via one or more photovoltaic module 4 on the roof. The shelter generates power by using one or more photovoltaic modules to maximize the efficiency of solar energy provided during daylight hours at a given location. The shelter comprises enough photovoltaic modules 4 to generate enough power to sustain the needed services provided within the structure/container (8, 9).

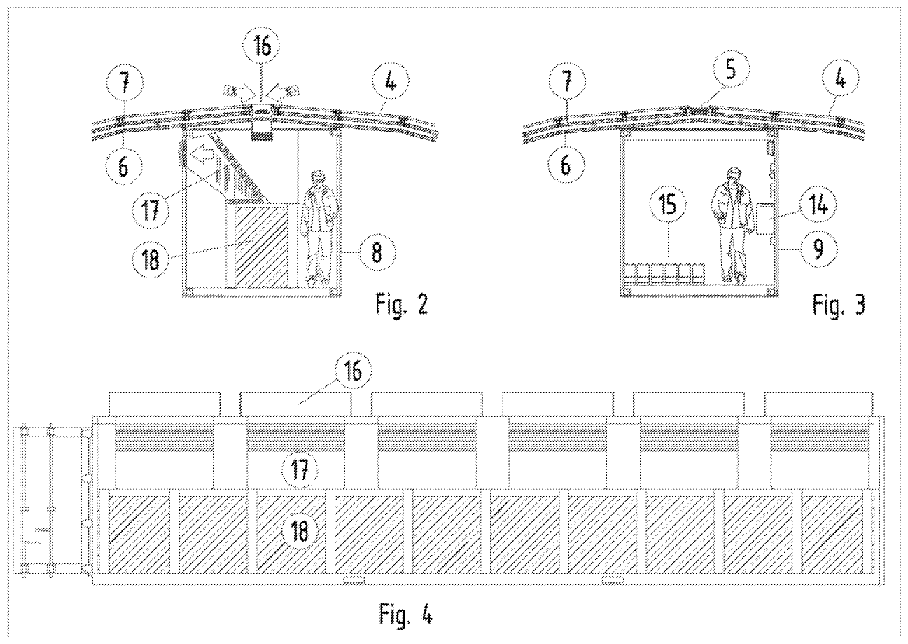

The shelter further comprises one or more water generators 17 for dehumidifying the surrounding air and storing the collected water in reservoirs 18, as illustrated in FIGS. 2 through 4. The water generators 17 intake warm, moist air through an alternating current electric fan that then passes the air over pipes which circulate refrigerated coolant to condense the air into liquid water which can then be collected and treated for various uses. The shelter within which the water generators are located may contain a direct current power to alternating current inverter or may utilize an inverter located elsewhere within a microgrid in the event more than one shelters are being used. Furthermore, a shelter containing water generators has dedicated air intake fans, humidity control equipment, and temperature control equipment which together ensure an optimal intake of ambient air into the shelter relative to ambient humidity. Additionally, the water reservoirs 18 can be coupled with a water treatment plant as needed in order to improve the quality of the water for consumption or use.

The water reservoirs 18 may be replaceable modules that can be transported directly with a vehicle 12 or to the structures or other users.

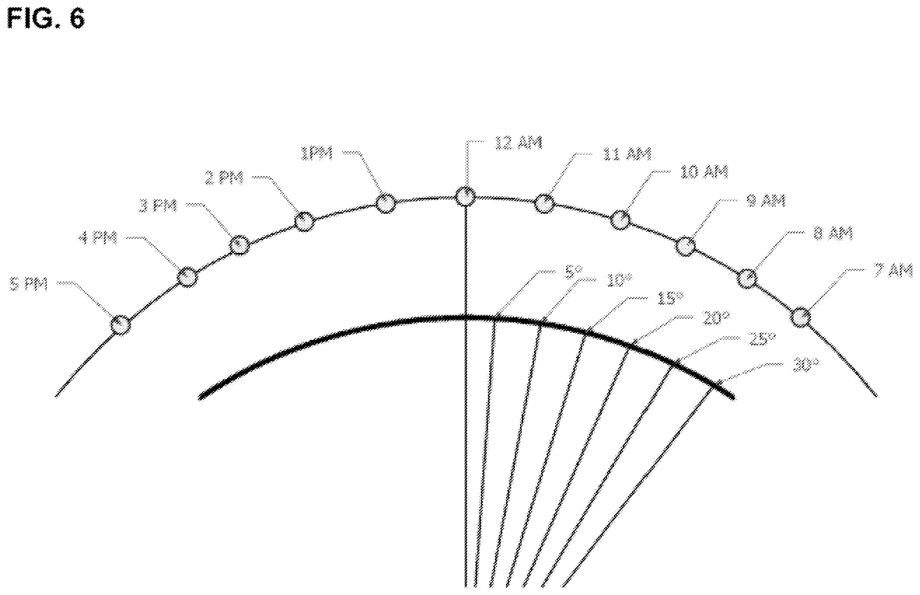

Underneath the roof sits the structures or containers 8 and 9, which can be secured with a foundation 10, as illustrated in FIGS. 1-3, and 6-17. The structures or containers 8 and 9 can be modified internally to serve a variety of functions. For example, the containers 8 and 9 may include functions for a temperature-controlled shelter, an electrical power distribution and/or battery storage center, a bathing area, a bathroom area, systems for purifying and storing drinking water, a temperature-controlled food storage, hospital for medical consultation and treatment, a kitchen, a workspace, a storage facility, an office space, a consultation space, and combinations thereof.

Roof

In some embodiments, the present disclosure comprises a roof 1, which extends in the longitudinal direction to the bottom 2 and is secured over the entire length with, e.g., ground anchors 3 at the bottom of the structure to the ground, foundation, cement pile, or micropile. In some further embodiments, the roof is arched; for example, the arch configuration is used because the shape optimizes the insolation of the shelter, regardless of its geographic location, eliminates shade that inhibits solar insolation, provides shaded and usable space beneath the roof structure, and allows for easy and cost-effective construction.

For example, as illustrated in FIG. 1, the arched roof 1 is partially or completely covered in the example with photovoltaic modules 4, except for a central aisle 5 in the region of the roof ridge, which serves for inspection purposes, provides an easy, low cost means of cleaning the roof's photovoltaic panels, and enables the intake of ambient air. The central aisle 5 can be configured to comprise one or more fans 16 for intaking ambient air, as illustrated in FIGS. 1 and 2. For example, the central aisle 5 may comprise one or more fans, such as, 1, 2, 3, 4, 5, 6, 8, 9, 10 or more fans. The one or more fans may be determined by several factors including use needs of the shelter.

In some embodiments, to obtain the maximum amount of energy, the arched roof 1 is fully occupied with photovoltaic modules 4 except for a central aisle 5 on the roof ridge, in which the one or more fans 16 are configured for the intake ambient air. In some other embodiments, the roof 1 is partially occupied by one or more photovoltaic modules 4; the number of one or more photovoltaic modules may be determined by several factors such as, but not limited to, energy requirements or insolation or both.

In some embodiments, the one or more photovoltaic modules are bifacial photovoltaic modules and are used to partially or completely cover the roof. The bifacial photovoltaic modules used may, for example, have black or silver, or painted frames or may be frameless, contain a minimum of sixty (60) photovoltaic cells, measure at least 1.7 m long, 1.0 m wide, 3.2 mm thick, and produce a minimum of 350 Wp each (per module), and may use colored or colorless photovoltaic glass. Each photovoltaic module forming the roof is aligned on its longitudinal axis and supported and secured on each side by metal (e.g., steel or aluminum) brackets that are attached to support framing. In some embodiments, one or more photovoltaic modules are interconnected in series to form the roof using factory-fitted pig tail wire connections and weather-proof and UV resistant equipment enclosures, where needed. For example, the photovoltaic modules are connected in series along the longitudinal axis of the structure; for example, all modules closest to the ground on one side of the structure are interconnected in series from left to right, which allows all modules on one side of the structure set at the same position and angle to produce power collectively and at the same rate. In some embodiments, the photovoltaic modules connected in series provide direct current power to charge-controlled batteries and/or to an inverter contained within the shelter or microgrid which then distributes alternating current power for use within the shelter, microgrid, or to an external power grid. In some embodiments, the roof, one or more photovoltaic modules, or combinations thereof are aligned at an optimized angle dependent on insolation to maximize solar energy capture during daylight hours. For example, the optimized module angle ranges from about 35 degrees at the foundation of the arch to about 2.5 degrees at the apex of the arch, with the angles of certain modules moving upwards from the foundation to the apex decreasing by about 2.5 to 5 degrees to ensure maximal solar energy capture.

In some embodiments, the roof further comprises a frame or framework of one or more individual pieces of connectable elements (e.g., plug-ins or equivalents thereof); that is, the one more individual pieces can be round or square piping arranged at an angle in a longitudinal pair and spaced to allow for the fastening of a photovoltaic module. For example, the frame is made of weather-proof pluggable and connectable elements 6, as illustrated in FIGS. 1 to 3. In some embodiments, the roof frame is made of cast steel, aluminum, polyethylene or combinations thereof.

For example, the frame or framework is usually 3-4 pre-sized pieces that are connected with metal brackets, knife-joints, or the like. Together, the frame's curved angle and connection brackets/joints allows each individual piece of frame to create the desired angle for the photovoltaic module to have. In some embodiments, polyethylene pieces can be used to create lower installation costs, primarily due to the weight savings during shipping compared to steel brackets. In addition, a polyethylene bracket could be used for high mobility applications, with or without a structure, like a container, to use.

In some embodiments, the frame's or framework's pre-sized pieces are sized to fit within a standard 20′ intermodal shipping container, e.g, so all of the frame components of a single stand-alone shelter can be packaged for shipping within the shelter itself. In some embodiments, the use of smaller pre-sized pieces can reduce the weight of each individual frame component, making each component easier to package, ship, and assemble. For example, the framework is of a size to be self-contained in the structure. In further embodiments, the frame's lighter weight pre-sized pieces enables the construction of the shelter's frame by human power and without the use of mechanical equipment. For example, the framework is hand assembled or mechanically assembled.

In some embodiments, the arched roof 1 is constructed to extend to a foundation, wherein a single-pipe or double-pipe construction supporting the arched roof is arranged alongside a ridge of the roof. The roof is anchored by, e.g., optional supports 3 on both ends where the roof meets the foundation or ground foundation. An example is illustrated in FIG. 1. Additionally, the structures or containers 8 and 9 support the apex of the roof arch. In some embodiments, the structure connects to the roof through connectors under the roof and in alignment, e.g., parallel, alignment to the roof.

In some embodiments, as illustrated in FIG. 1, the optional supports 3 are directed downward from the roof to the foundation. In some embodiments, the supports can be configured in a manner to provide stiffness and/or strength in order to resist the internal forces (vertical forces of gravity and lateral forces due to wind, snow, and earthquakes) and guide them safely to the ground. For example, the supports for the roof can be, such as, but not limited to, cross bars, tie-backs, additional downward bars, connections, joints, stakes, restraints, and/or combinations thereof. As illustrated in FIG. 1 the optional supports are round stock steel pipe. Further, in some embodiments, the optional supports 3 in FIG. 1 represent micropiles used to secure the roof to the foundation or ground. In some embodiments, the supports can be either at the end or at any intermediate point along the shelter or a microgrid.

Structure

As provided in the present disclosure, the shelter comprises a structure arranged underneath the roof. In some embodiments, the shelter is a freight or shipping container; shipping containers are also called intermodal shipping containers or conex containers, all of which are disclosed herein. In some embodiments, the structure may also be substantially prefabricated to include walls and top and bottom floors. Further, in some embodiments, the structure may be in a collapsed form that permits the entire structure to be shipped in a shipping container. Once the shipping container reaches its final destination, the collapsed structure can be removed from the container and converted to an expanded state that provides a habitable structure.

In some embodiments, when the structure is a freight or shipping container, the structure is made out of steel or corrugated steel. Examples of typical dimensions of shipping containers include: the exterior dimensions of ISO Shipping Containers are 8′0″ (2.438 m) wide, and 8′6″ (2.591 m) tall. The most common lengths are 20′ (6.058 m) and 40′ (12.192 m). Shipping container dimensions are held to very specific standards. The International Standard for Organization (ISO) requires that all containers are built to within a few millimeters of one another so they can be stacked on container ships without issue. Containers are generally quantified in terms of twenty-foot equivalent units (TEU's) and are most commonly built in 20′ and 40′ lengths. Standard containers have an outside height of 8′6″ tall, and “High Cube” containers have an outside height of 9′6″.

In some further embodiments, the structure can be made from, but not limited to, aluminum, polyethylene, fiberglass, and combinations thereof to create an enclosure or for example, a molded enclosure. These uses of these alternative materials for the structures provide mobility benefits due to their lightweight nature compared to steel and the ease at which they can be moved without the need for heavy transportation equipment.

In some embodiments, the structures or containers are painted. For example, the structures are painted with flat, matte, shiny, reflective or combinations thereof. In some embodiments, the paints can be, but not limited to, high albedo paints and/or paints with reflective glass beads. In yet other embodiments, the painted structure is able to provide an additional reflective index that enables an increase in efficiency of the one or more photovoltaic modules on the roof.

For example, the painted structure can provide an additional reflective value that when used in coordination with a bifacial photovoltaic module, can increase the power production efficiency of a module by between about 1% to about 30%. In some embodiments, the orientation of the painted shelters beneath the roof enables an accurate prediction of solar reflection values that, when used in coordination with a bifacial photovoltaic module, enables for an accurate prediction of the amount of increased peak power a bifacial photovoltaic module can produce relative to insolation. For example, the kilowatt hours per square meter per day at a given location may result in a photovoltaic module producing 350 Wp without the use of a shelter with reflective paint properties but may produce 455 Wp or more when a shelter with reflective paint is used. Additionally, the arched shape of the roof which is aligned at optimized angles also increases the amount of energy that can be captured by the invention.

In some embodiments, the structure can withstand certain weather conditions and electronic signals. That is, in embodiments of the disclosure, the structure is configured for withstanding natural disasters, such as, but not limited to, Category 5 hurricanes, tornadoes, earthquakes, vertical flooding float, and combinations thereof. For example, the construction of the structure is designed to be stormproof and conform to the most stringent zoning and building codes. In yet further embodiments, the structure is configured to withstand artificial disasters, e.g., electric and magnetic fields (EMF), such as radiation, that are associated with the use of electrical power and various forms of natural and man-made lighting. EMFs are typically grouped into one of two categories by their frequency: (1) non-ionizing: low-level radiation which is generally perceived as harmless to humans (e.g., microwave ovens, computers, wireless networks, Bluetooth® devices, power lines, and magnetic resonance imagining (MRIs)); and (2) Ionizing: high-level radiation which has the potential for cellular and DNA damage (e.g., sunlight, x-rays, and some gamma-rays).

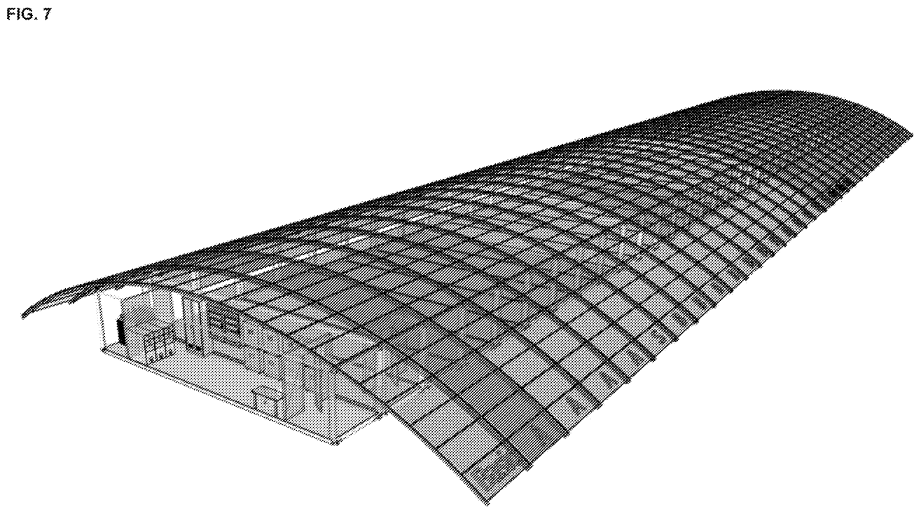

As provided in FIGS. 1 to 3 and 7-20, the structure, such as a shipping container, is arranged longitudinally (i.e., horizontal), latitudinally (i.e., vertical) in view of the roof or in any orientation the roof. In some embodiments, when the structure is arranged longitudinally (see FIGS. 1 to 5), one or more structures are arranged one behind the other, as provided in FIG. 5 to form a microgrid. In other embodiments, where one or more structures are arranged latitudinally (i.e., vertical) in view of the roof (see FIGS. 7 to 20), the structures are arranged adjacent to one another to for a microgrid, as provided in FIG. 7.

In some embodiments, the one or more structures act as further supports to the roof through the mounting of brackets, e.g., metal brackets or equivalents thereof, which secure the apex of the roof to the top of the structures. For example, regardless of the orientation of the structure or container, the roof of the container/structure can provide the structure upon which roof supports are attached. In some embodiments, a steel bracket is used to secure the roof to the shipping container. In yet further embodiments, steel brackets may also be used to connect one container to another and can assist in helping to rapidly deploy the system by providing alignment guidance.

In some embodiments, the roof bracket is designed to allow the roof support to rest at the desired angle to maximize the photovoltaic efficiency of the roof. In addition to the bracket, conduit for water lines and/or electrical cables can be used extend the shelter.

As provided in FIGS. 1-3, since the bottom roof 1 is fixed through the use of metal brackets and resting on the containers or structures 8, 9, the height of the container 8, 9 represents in the example shown, the maximum height of a room formed by the container. In a further embodiment, the ceiling height of the shelter could increase when the structure is on a foundation. For example, the floor 2 could be excavated under the roof 1. In yet further embodiments, the structure may include a ground foundation (10) for the structure, as provided in FIG. 1. In some embodiments, the ground foundation (10) is gravel, sand, cement, an anchor plate, or any combination thereof. Additionally, the ground foundation may include a fastener system depending on the nature of the foundation in which the structure resides.

The foundation or ground foundation on which the shelter of the present disclosure may reside includes, but are not limited to, soil, sand, clay, rocks, man-made platforms (e.g., floating barges or offshore platforms), earth that has been through a natural disaster such as hurricane, tornado, fires, etc.

As illustrated in FIGS. 1-3, 5, and 7-20, the use of containers (8, 9) also serve as storage for the equipment of the shelter. In some embodiments, the exposed and open sides of the shelters can be partially or fully closed by, for example, dust protection, wind walls, waterproof protection, or any combination thereof. In some other embodiments, as provided in FIGS. 1-3, space or spaces between the containers 8, 9 and the supports 11 provide for vehicles storage 12, for example electrically driven vehicles, and/or charging stations, paths for people or beds 13 for crops. As provided in the microgrids or with one shelter, open space may be utilized to serve different functions or uses including, but not limited to, agriculture, such as aquaponic or hydroponic systems, general storage, animal or livestock shelter, equipment placement and or/storage, or as a shaded area.

In some embodiments, the structures or containers 8, 9 comprise charge controllers and power inverters 14 and charged and rechargeable batteries 15, as illustrated in FIG. 3. For example, the batteries 15 serve as energy storage for the operation of the presently disclosed shelters, and in further embodiments, the vehicles 12 and as energy sources for other uses in the structure or as usable power that can be discharged into an external power grid. The batteries may be distributed with the vehicles 12 and empty batteries 15 may be brought back for recharging. Additionally, for example, the batteries may be lithium ion batteries, lead acid batteries, or any other battery type suitable for use with photovoltaic systems. To ensure operational capacity of the batteries, the structure may be temperature-controlled to the optimal temperature for battery power storage.

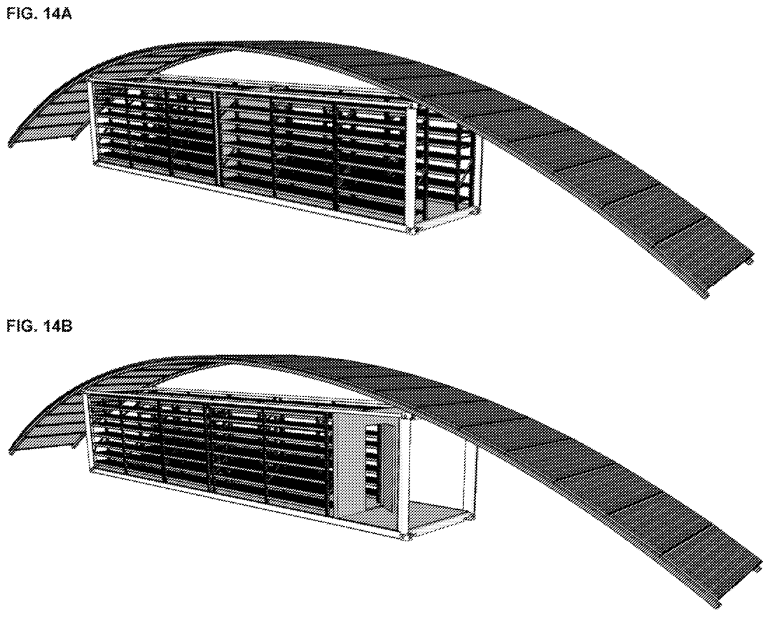

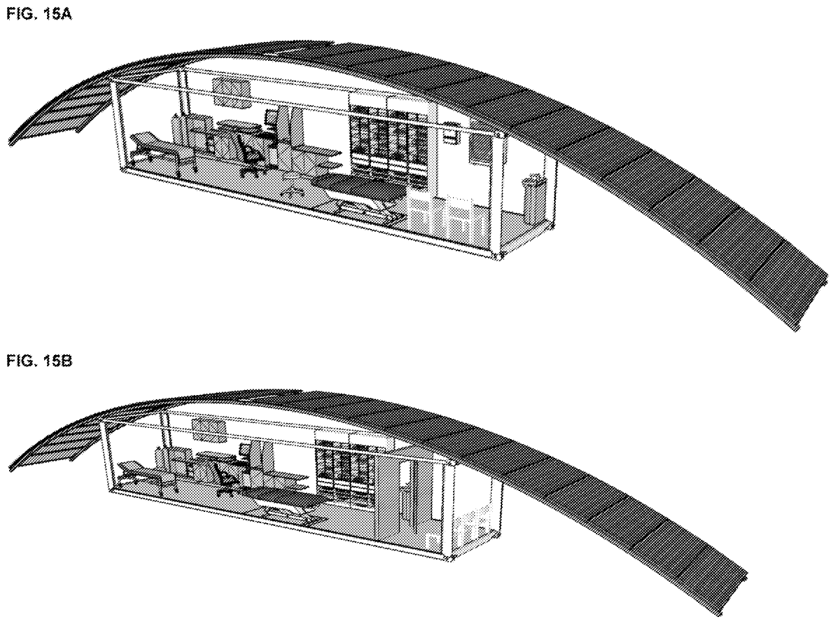

In some embodiments, below the one or more fans 16 in the roof, the structures or containers 9 are arranged, which are equipped with water generators 17 for separating the humidity and associated water storage 18 (as exemplified in FIGS. 2 and 4). In some embodiments, the water generators 17 are powered with direct current in order to avoid or minimize the use of inverters. In yet further embodiments, as provided in FIGS. 2 and 14, the water reservoirs 18 can be coupled to a water treatment plant (not shown) or water treatment system (note shown), as needed and to improve the quality of the water and/or to recycle and treat waste water.

In some embodiments, as illustrated in FIGS. 2 and 4, the water reservoirs 18 may be replaceable modules that communicate directly with vehicles 12, structures, or be transported to users. In yet further embodiments, the water may be filled into smaller storage tanks and/or transport containers in order to reach the needed area for storage or for consumption.

In some embodiments, the structures can be utilized to serve various functions needed for human survival. That is, one or more structures are used as a temperature-controlled room and/or a non-temperature-controlled room. In some embodiments, the structures can be used as rooms for, but not limited to, a temperature-controlled shelter, an electrical power distribution and generation center, a bathing area, a bathroom area, systems for purifying and storing drinking water, a temperature-controlled food storage, hospital for medical consultation and treatment, a kitchen, a workspace, a storage facility, an office space, a consultation space, aquaponic systems, hydroponic systems, electric vehicle parking and charging stations, communication hubs and operational command centers, equipment bays, critical equipment storage, and combinations thereof.

Mobility Shelters

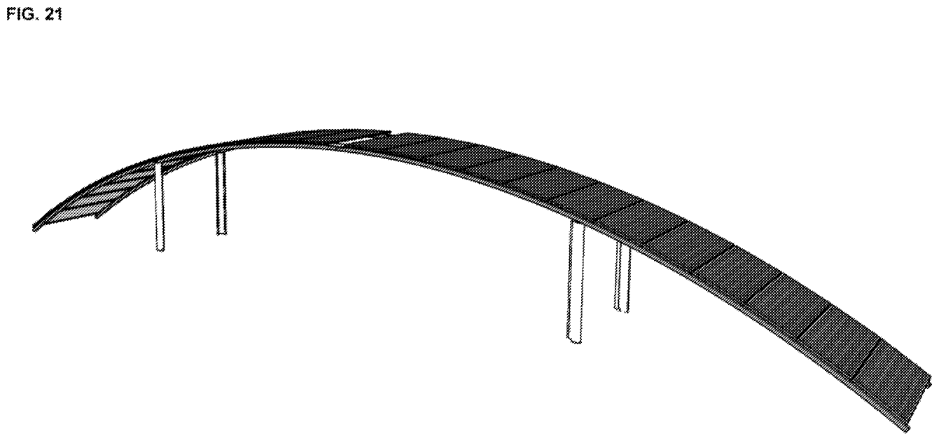

In some embodiments, the presently disclosed shelter may be built without the addition of any support structure underneath the arched roof 1, as illustrated in FIG. 21. Instead, the shelter includes the roof and lightweight supports and vertical stanchions made of lightweight alloy or composite materials to support the photovoltaic modules on the roof. The lightweight roof supports and stanchions enable for easy transport and can be constructed in such a way to create a rigid framework to adequately support the roof a photovoltaic modules for durations of time absent high wind conditions. The roof would then be secured to the ground or foundation through the use of micropiles. In some embodiments, the shelter includes the roof and lightweight supports, and the roof is attached to a foundation through the use of micropiles. This type of system is lightweight and highly mobile, capable of being packaged to be dropped out of a plane to a remote location, moved in a pickup truck, or carried by several people for short distances before being set up.

### EXAMPLES

The following examples are intended to be illustrative and are not meant in any way to limit the scope of the disclosure.

### Example 1: Microgrid

FIGS. 5, 7, and 20 illustrates a microgrid of the present disclosure. The microgrid comprises shelters with structures of the same and different uses. As illustrated in FIG. 7, the microgrid comprises several shelters adjacent or joined together. For example, a microgrid is illustrated and in this embodiment, able to house about 304 people in a collection of about thirty-eight (38) structures or ShelterCubes. For example, ShelterCubes use customized 40′ ISO shipping containers. Each ShelterCube is designed to house up to eight (8) people while providing temperature-controlled sleeping and lounge areas, internet connectivity, charging stations for mobile phones, and provide enough electricity to sustain the needs of the up to eight people per day. In addition, the microgrid comprises shelters with structures that are used to generate and store power, i.e., PowerDomes. In this example, each PowerDome Sustainable Humanitarian Relief (“SHR”) houses two gender-specific shelters that each contain five (5) private toilet stalls, five (5) shower stalls, and up ten (10) sinks with mirrors, i.e., these are entitled ComfortCubes. PowerCubes and ComfortCubes are further exemplified below.

### Example 2: PowerCubes

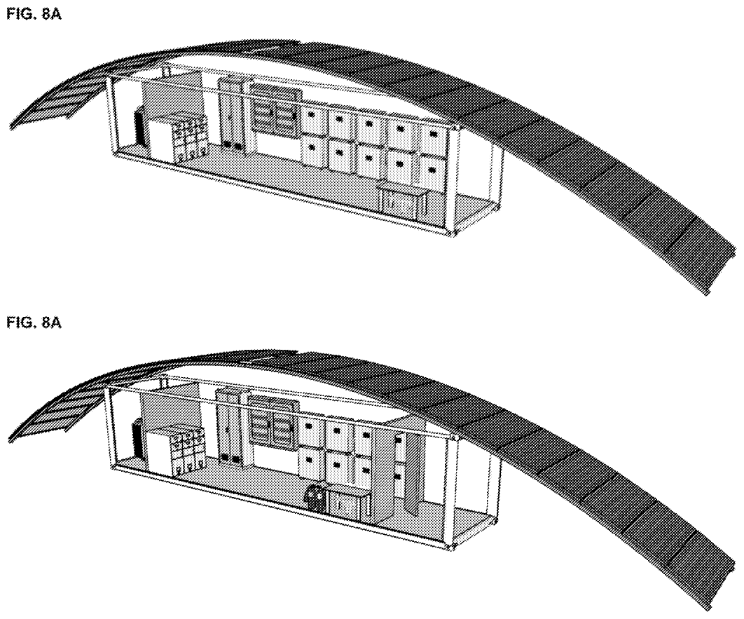

FIGS. 8A and 8B exemplify PowerCubes according to the present disclosure. PowerCubes function to create and store electrical power generated by the roof of the shelter. For example, in some embodiments, the vestibule can provide the occupants a way to control thermal conditions within the shelter by eliminating the introduction of air directly into the entire shelter once the exterior door is opened; a protection against the outside environment for shelters that contain sensitive equipment and electronics; and an extra layer of security against anyone that may not otherwise have access to the internal parts of the shelter. Additionally, in some instances the shelter may be designed with a vestibule that connects to an adjoining shelter with such connection sealed with rubber insulation or gaskets, or any combination thereof, to provide a passageway between shelters or to other parts of the microgrid that are temperature controlled and protected from the elements. FIG. 8B, compared to FIG. 8A, shows a vestibule built into the shelter.

Table 1 describes exemplary PowerCubes with the following specifications:

TABLE 1
Cube Specification

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Emergency System | Smoke detector and fire suppression system |
| Active ventilation | 5.500 m³/h (temp. controlled) |
| Power Rating | 1 kVA |
| AC Power Supply | AC distribution box with power sockets |
| Lighting | 4× 36 W LED |
| Storage | Spare parts cabinet |
| Furniture | 1× desk with 2× chairs |
| (on-grid application only) | |
| Options | Transformer and middle voltage switchgear |
| (on-grid application only | |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System and Battery Storage-Off-Grid Applications

| | |
|---|---|
| Manufacturer | Victron |
| Type | Off-Grid |
| Output Voltage | 240, 400 V |
| Frequency | 50 Hz |
| Charge Controller and | Victron |
| Monitoring System | |
| Battery Management System | Smart 1 |
| Battery Manufacturer | Hoppecke |
| Battery Voltage | AGM/48 V |
| Battery Output | 20 kWh |
| Battery Charge Cycles | 2,000 (60% DoD) |
| Total Energy Storage | 500 kWh |

### Example 3: ShelterCubes

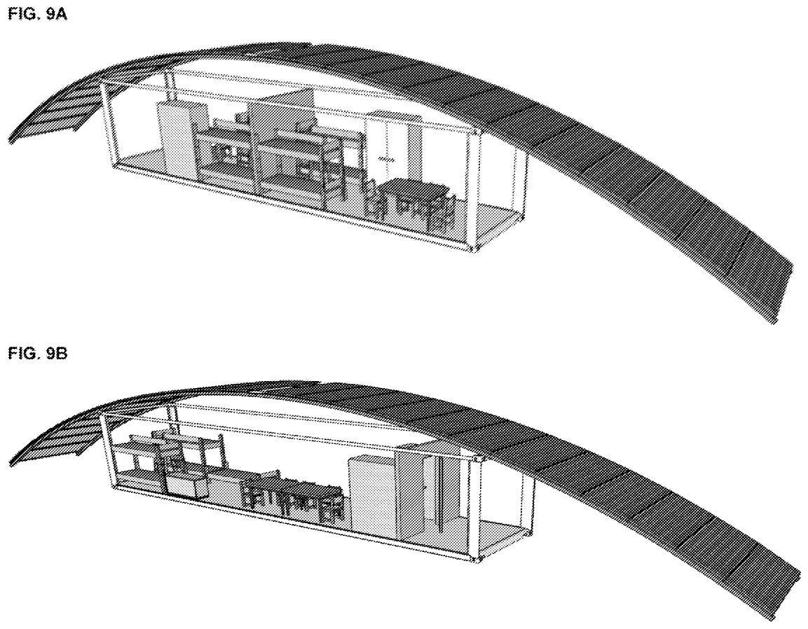

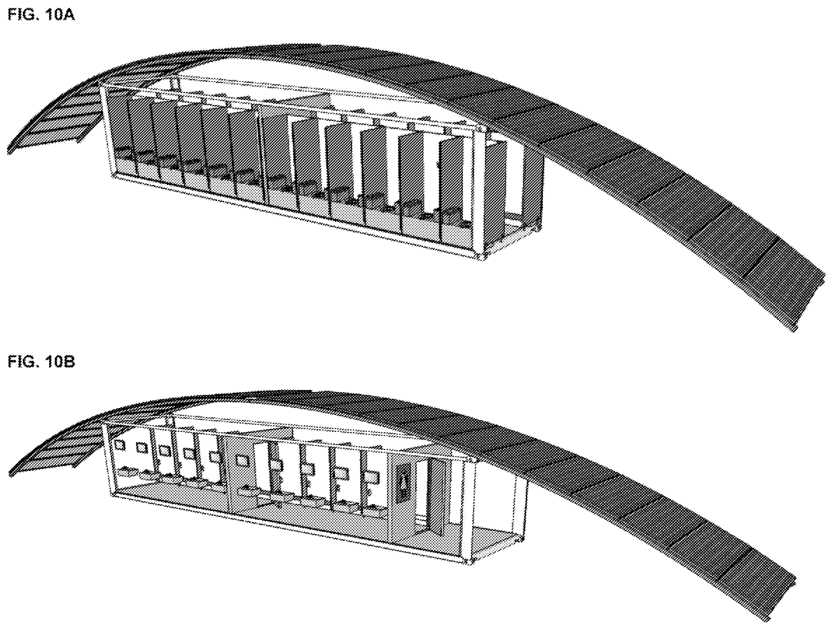

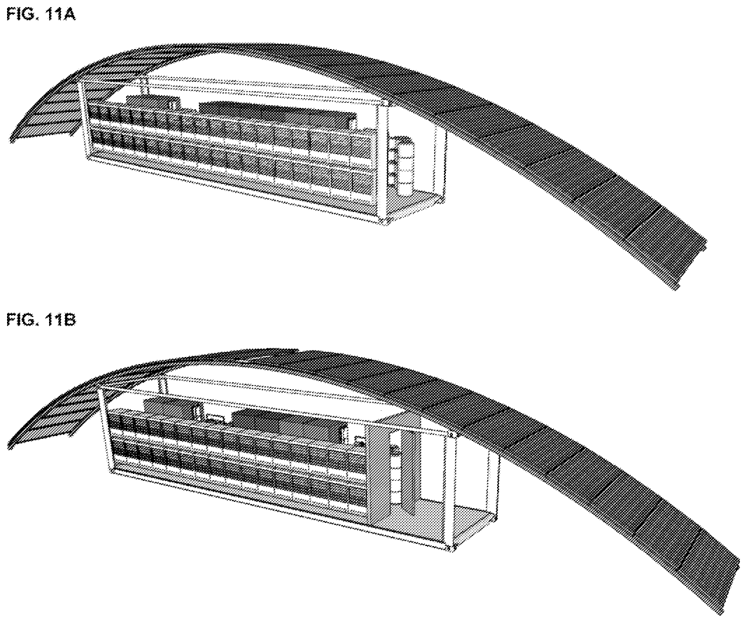

FIGS. 9A and 9B exemplify ShelterCubes according to the present disclosure. ShelterCubes function to provide sleeping quarters with one or more beds, table, and/or closet space. FIG. 9B, compared to FIG. 9A, shows a vestibule built into the shelter.

Table 2 describes exemplary ShelterCubes with the following specifications:

TABLE 2
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Emergency System | Smoke detector and fire suppression system |
| Active ventilation | 5.500 m³/h (temp. controlled) |
| Rated Power | 5 kVA |
| Useable Power per Person | 12.33 kWh (based on a 5-Person Unit) |
| Day per Person | |
| Total Indoor Living Area | 28.5 m² |
| Number of Living Units | 1 (Family Unit configuration) or 2 |
| | (Max Unit configuration) |
| Living Area per Person- | 5.72 m² |
| Family Unit | |
| Living Area per Person- | 3.57 m² |
| Max Unit | |
| AC Power Supply | AC distribution box with 4× power sockets |
| Lighting | 4× 36 W LED |
| Furniture-Family Unit | 5× beds, 2× tables, 6× chairs |
| Furniture-Max Unit | 8× beds (2× bunk per unit), 2× tables |
| | (1× per unit), 8× chairs (4× per unit) |
| In-Unit Storage | 2× 16 m³ wardrobes (0.4 m³ storage per |
| | person (based on Max Unit) |
| Heating | 2× built-in units |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 4: ComfortCubes—Gender-Specific Toilets and Showers

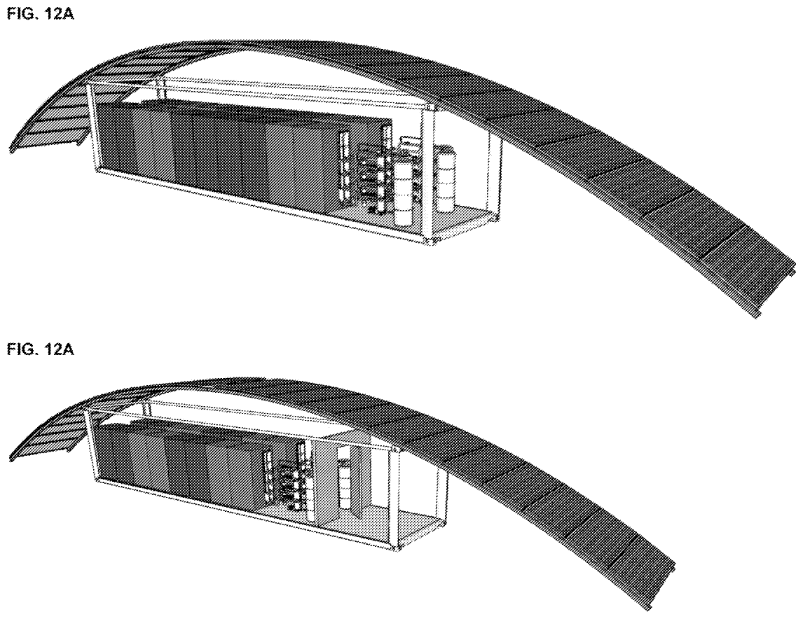

FIGS. 10A and 10B exemplify ComfortCubes according to the present disclosure. ComfortCubes function to provide one or more gender-specific toilets stalls, shower stalls, sinks with mirror. FIG. 10B, compared to FIG. 10A, shows a vestibule built into the shelter.

Table 3 describes exemplary ComfortCubes—toilets with the following specifications:

TABLE 3
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Emergency System | Smoke detector and fire suppression system |
| Active ventilation | 5.500 m³/h (temp, controlled) |
| Rated Power | 15 kVA |
| Gender-Specific Shower | 1× male, 1× female |
| Units | |
| Male Shower Unit | 5× private shower stalls, 5× sinks with mirrors |
| Female Shower Unit | 5× private shower stalls, 5× sinks with mirrors |
| Drainage and Water | Built-in with gray water collection |
| Recycling | |
| Lighting | 4× 36 W LED |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 5: HydroCubes

FIGS. 11A and 11B exemplify HydroCubes according to the present disclosure. HydroCubes are configured for generation, treatment/purification, and storage of water. FIG. 11B, compared to FIG. 11A, shows a vestibule in the shelter.

Table 4 describes exemplary HydroCubes with the following specifications:

TABLE 4
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Emergency System | Smoke detector and fire suppression system |
| Active ventilation | 5.500 m³/h (temp. controlled) |
| Rated Power | 37 kVA |
| Water Source Required | No |
| Water Production Units | 36 |
| Water Production l/h per Unit | 3 |
| Water Production l/h per | 108 |
| Cube | |
| Power Consumption per Unit | 1,000 W (average) |
| Water Storage per Cube | Up to 12,000 L (up to 6,000 L fresh water, |
| | up to 6,000 L drinking water) |
| Water Treatment per Cube | Preventative stainless steel UV disinfection |
| | and mineralization |
| Water Quality Monitoring | Full digital display with remote monitoring |
| Interior Lighting per Unit | 4× 36 W LED |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 6: HydroCubes—Storage

FIGS. 12A and 12B exemplify HydroCubes—Storage according to the present disclosure. HydroCubes—Storage is configured for the storage of water generated by the shelters of the present disclosure. FIG. 12B, compared to FIG. 12A, shows a vestibule in the shelter.

Table 5 describes exemplary HydroCubes—Storage with the following specifications:

TABLE 5
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene (PE 100) |
| | cladding |
| Emergency System | Smoke detector and fire suppression system |
| Active ventilation | 5.500 m³/h (temp. controlled) |
| Rated Power | 6 kVA |
| Water Source Required | Yes |
| Water Feed System | Electric pumps (head dependent) |
| Water Production Unit Type | Reverse Osmosis Desalination with cascade filter |
| Daily Water Production | Up to 24,000 L |
| Fresh Water Storage | Up to 14,000 L |
| Drinking Water Storage | Up to 9,600 L |
| Interior Lighting per Unit | 4× 36 W LED |

Inverter System-On-Grid Applications

| | |
|---|---|
| Manufacturer | KACO |
| Type | String, On-Grid |
| Output Voltage/Frequency | 400 V, 50 Hz |
| Monstoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and Monitoring | Victron |
| System | |

### Example 7: ColdCubes

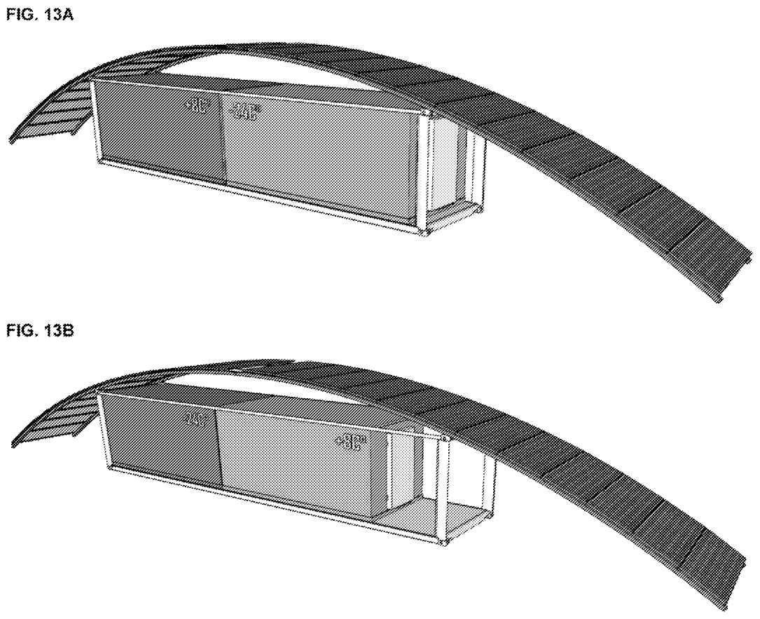

FIGS. 13A and 13B exemplify ColdCubes according to the present disclosure. ColdCubes are configured for refrigeration and storage of perishable food items. FIG. 13B, compared to FIG. 13A, shows a vestibule in the shelter.

Table 6 describes exemplary ColdCubes with the following specifications:

TABLE 6
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Rated Power | 10 kVA |
| Cube Units | 1× cold storage, 1× freezer storage |
| Cold Storage Area | 21 m³ |
| Cold Storage | 4-8° C. |
| Temperature Range | |
| Freezer Storage Area | 21 m³ |
| Freezer Storage | −18-30° C. |
| Temperature Range | |
| Temperature Controller | TS 125 Thermostat with humidity control |
| Interior Lighting per Unit | 4× 36 W LED |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 8: Storage Cubes

FIGS. 14A and 14B exemplify Storage Cubes according to the present disclosure. Storage Cubes are configured for the storage with various shelving units. FIG. 14B, compared to FIG. 14A, shows a vestibule in the shelter.

Table 7 describes exemplary Storage Cubes with the following specifications:

TABLE 7
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Rated Power | 4 kVA |
| Dry Storage Area | 42 m³ (including 300 m² of built-in shelving |
| Air Circulation System | Axial fan (1,200 m³/h rating) |
| Security | Steel door with lock, alarm system, and PIR |
| | motion sensor |
| Temperature Controller | TS 125 Thermostat with humidity control |
| Interior Lighting per Unit | 4× 36 W LED |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 9: CareCubes

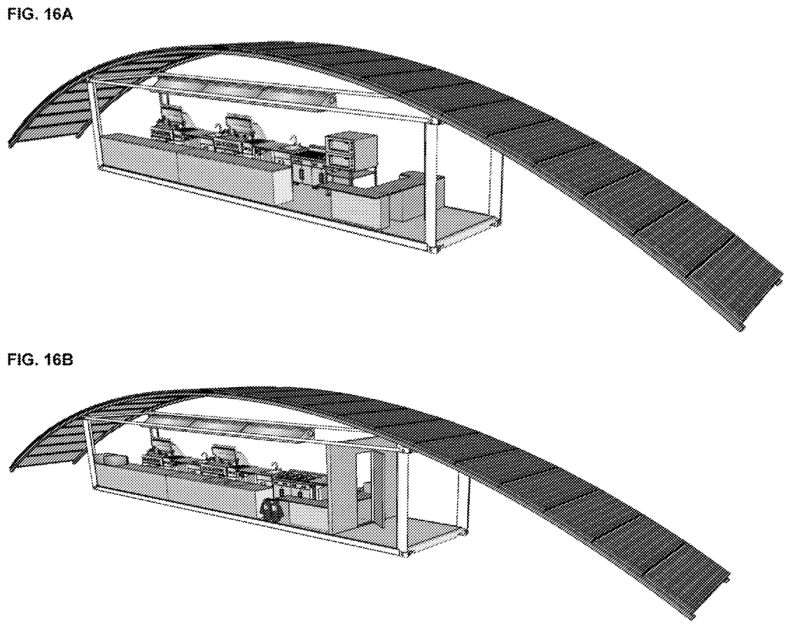

FIGS. 15A and 15B exemplify CareCubes according to the present disclosure. CareCubes are configured for replicating a hospital in order to provide for medical consultation and treatment. FIG. 15B, compared to FIG. 15A, shows a vestibule in the shelter.

Table 8 describes exemplary CareCubes with the following specifications:

TABLE 8
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Rated Power | 5 kVA |
| Medical Equipment | Examination table, space for additional items |
| | (up to rated power) |
| Air Conditioning and Heat | Yes |
| Refrigerated Medicine | Yes |
| Storage | |
| Furniture | 1× Treatment gurney, 1× desk, 3× chairs, |
| | 1× storage cabinet |
| Interior Lighting per Unit | 6× 36 W LED |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 10: KitchenCubes

FIGS. 16A and 16B exemplify KitchenCubes according to the present disclosure. KitchenCube are configured for providing a kitchen with sinks, ovens, microwaves, refrigeration, prep areas, and/or cabinets. FIG. 16B, compared to FIG. 16A, shows a vestibule in the shelter.

Table 9 describes exemplary KitchenCubes with the following specifications:

TABLE 9
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Rated Power | 35 kVA |
| Serving Capacity | 1,250 Persons |
| Preparation Sink | Examination table, space for additional items |
| | (up to rated power) |
| Preparation Counter Space | Yes |
| Refrigerators | 5× 170 L units |
| Microwave Oven | 3× units |
| Hot Air Oven | 2× units |
| Deep Fryer | 2× double units |
| Roasting Grills | 2× units |
| Ventilation Hood | 4,250 m²/h |
| Serving Counter | Yes |
| interior Lighting per Unit | 4× 36 W LED |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 11: OfficeCubes

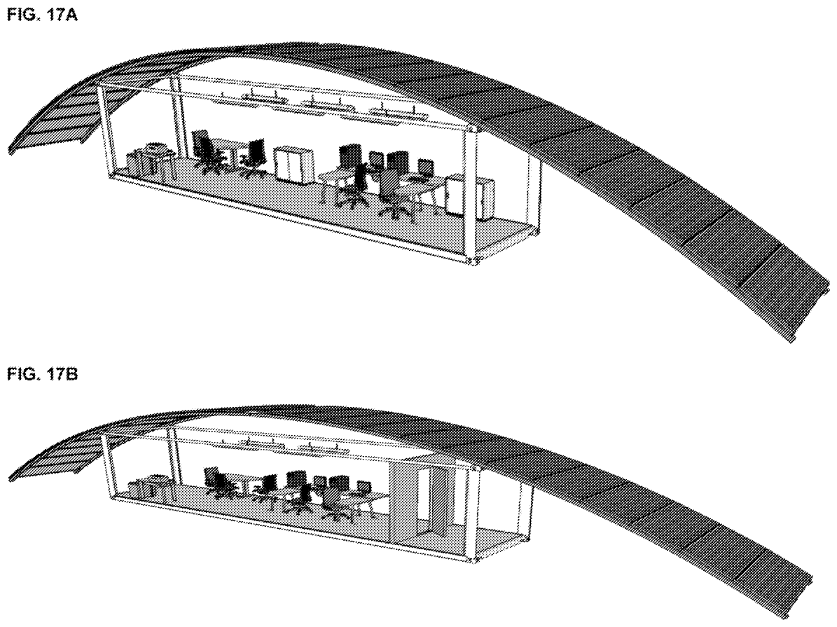

FIGS. 17A and 17B exemplify OfficeCubes according to the present disclosure. OfficeCubes are configured for office space with desks, conference tables, office chairs, lighting, storage, and/or printers. FIG. 17B, compared to FIG. 17A, shows a vestibule in the shelter.

Table 10 describes exemplary OfficeCubes with the following specifications:

TABLE 10
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Rated Power | 4 kVA |
| Air Conditioning and Heat | Yes |
| Furniture | 1× conference table, 2× desks, 5× chairs, |
| | 2× printer tables, 2× storage cabinets |
| Interior Lighting per Unit | 6 × 36 W LED |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 12: HydroponicCubes

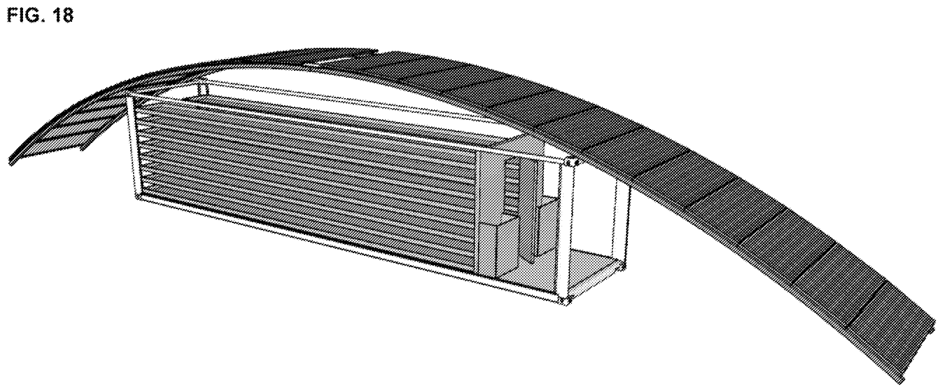

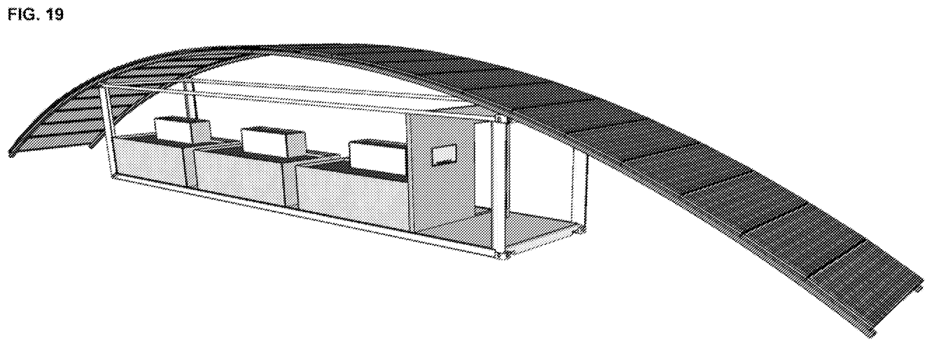

FIG. 18 exemplifies HydroponicCubes according to the present disclosure. HydroponicCubes are configured for indoor growth of plants and organic vegetables and are configured for the use of stored or generated water, LED growing lights, water pumps, growing apparatus, and humidity control equipment Table 11 describes exemplary HydroponicCubes with the following specifications:

TABLE 11
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Rated Power | 12 kVA |
| Planting Area | Up to 128 m² |
| Constant Temperature Range | 15-25° C. |
| Constant Fresh Air Supply | 4× volume in m³/h |
| Self-sufficient Water Circuits | 2 |
| Interior Lighting per Unit | LED (as-needed based on growing needs) |
| Water Pumps | 2× (100 W) |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

### Example 13: AquaponicCubes

FIG. 19 exemplifies AquaponicCubes according to the present disclosure. AquaponicCubes are configured for indoor growth of fish and other aquatic life and are configured for the use of stored or generated water, LED lights, water pumps, marine habitat basins, and mechanical and biological filters Table 12 describes exemplary AquaponicCubes with the following specifications:

TABLE 12
Cube Specifications

| | |
|---|---|
| Dimensions of Cube | 12.00 × 2.38 × 2.28 meters |
| (L × W × H) | |
| External Material | Painted Corten Steel |
| Internal Materials | 50 mm rigid foam insulation, Polyethylene |
| | (PE 100) cladding |
| Rated Power | 4 kVA |
| Basins | PE 100 |
| Filter Systems | 3× (seperated) |
| Filters | Mechanical and biological |
| Interior Lighting per Unit | 4× 36 W LED |
| Water Pumps | 2× (100 W) |

Inverter System-On-Grid Applications

| | |
|---|---|
| Manufacturer | KACO |
| Type | String, On-Grid |
| Output Voltage/Frequency | 400 V, 50 Hz |
| Monitoring System | KACO |

Inverter System-Off-Grid Applications

| | |
|---|---|
| Manufacturer | Victron |
| Type | Off-Grid |
| Output Voltage/Frequency | 240/400 V, 50 Hz |
| Frequency | 50 Hz |
| Charge Controller and | Victron |
| Monitoring System | |

It should be understood, of course, that the foregoing relates to exemplary embodiments of the disclosure and that modifications may be made without departing from the spirit and scope of the disclosure as set forth in the following claims.

What is claimed is:

1. A solar-powered shelter for producing and storing electrical power and/or water comprising:
a roof arranged with one or more photovoltaic modules and/or one or more devices for dehumidifying ambient air; and
a structure arranged underneath the roof.

2. The shelter according to claim 1, wherein the structure forms a room chosen from a temperature-controlled shelter, an electrical power distribution and generation center, a bathing area, a bathroom area, systems for purifying and storing water, a temperature-controlled food storage, a hospital for medical consultation and treatment, a kitchen, a workspace, a storage facility, an office space, a consultation space, and combinations thereof.

3. The shelter according to claim 1, wherein the structure is made from a material chosen from metal, fiberglass, polyethylene, and combinations thereof.

4. The shelter according to claim 1, wherein one or more shelters are formed adjacent to each other to form a microgrid.

5. The shelter according to claim 1, wherein the shelter is configured for withstanding natural or artificial disasters chosen from Category 5 hurricanes, tornadoes, earthquakes, vertical flooding float, electrical magnetic pulses, and combinations thereof.

6. The shelter according to claim 1, wherein the shelter elf produces an usable quantity of electricity per day per person.

7. The shelter according to claim 1, wherein the roof is configured into an arch formation and each end of the roof extends until reaching a foundation.

8. The shelter according to claim 7, wherein the foundation is chosen from son, sand, day, rocks, man-made platforms, earth from a hurricane, a tornado, or a fire, and combinations thereof.

9. The shelter according to claim 7, wherein the roof comprises a framework of plug-in, connectable elements.

10. The shelter according to claim 9, wherein the connectable elements are metal.

11. The shelter according to claim 9, wherein the roof is in a form of a single-tube or double-tube construction.

12. The shelter according to claim 1, wherein the one or more photovoltaic modules fully cover a top portion of the roof except for a central aisle on a roof ridge.

13. The shelter according to claim 12, wherein the roof ridge comprises one or more fans configured for intaking ambient air.

14. The shelter according to claim 1, wherein the one or more photovoltaic modules are single-directional or bi-directional photovoltaic modules, which are aligned on a longitudinal axis on the roof.

15. The shelter according to claim 1, wherein the structure is coated in a paint chosen from high albedo paints, paints with reflective glass beads, and combinations thereof.

16. The shelter according to claim 15, wherein the structure is constructed of painted steel.

17. The shelter according to claim 7, wherein the roof, the one or more photovoltaic modules, or combinations thereof are aligned at an optimized angle in order to maximize energy capture efficiency.

18. The shelter according to claim 17, wherein the optimized angle ranges from about 35 degrees at the foundation of the arch to about 2.5 degrees at the apex of the arch, with the angles of certain modules moving upwards from the foundation to the apex decreasing by about 5 to 2.5 degrees to ensure maximal solar energy capture.

19. The shelter of claim 1, wherein the structure connects to the roof through one or more brackets under the roof and in alignment to the roof.

20. The shelter according to claim 1, wherein the structure further comprises a charge controller, direct current to alternating current power inverter, batteries, and shelves for charged and uncharged batteries.

21. The shelter according to claim 20, wherein the structure comprises power equipment configured for charging electric vehicles.

22. The shelter according to claim 13, wherein the structure further comprises one or more water generators for separating humidity and associated water reservoirs from the ambient air intake.

23. The shelter according to claim 1, wherein the structure further comprises one or more toilets for human waste disposal.

24. The shelter according to claim 1, wherein the structure further comprises bathing stalls configured for providing hot and ambient water for human use.

25. The shelter according to claim 1, wherein the structure further comprises one or more water storage tanks for storing up to at least 6,000 liters.

26. The shelter according to claim 1, wherein the structure further comprises equipment necessary for aquaponic systems.

27. The shelter according to claim 1, wherein the structure further comprises equipment necessary for hydroponic usage and systems.

28. The shelter according to claim 1, wherein the structure further comprises equipment necessary for the sheltering of animals and/or livestock.

29. The shelter according to claim 1, wherein the structure is configured as a temperature-controlled room.

30. The shelter according to claim 29, wherein the room is configured for housing people, and providing internet connectivity and charging stations.

31. The shelter according to claim 1, wherein the structure is a temperature-controlled storage area for cold storage of food and liquids.

32. The shelter according to claim 29, wherein the room comprises medical equipment and devices with one or more electrical power supplies to serve as a hospital.

33. The shelter according to claim 29, wherein the room comprises cooking equipment to serve as a kitchen.

34. The shelter according to claim 33, wherein the cooking equipment is chosen from stoves, ovens, fryers, microwaves, and combinations thereof with one or more electrical power supplies.

35. The shelter according to claim 29, wherein the room comprises one or more shelves and other furniture configured for storage.

36. A solar-powered shelter for producing and storing electrical power and/or water comprising:
a roof arranged with one or more photovoltaic modules and/or one or more devices for dehumidifying ambient air.

37. The shelter according to claim 36, wherein the roof is supported by lightweight supports and vertical stanchions, and the roof is attached to a foundation through the use of micropiles.

38. The shelter according to claim 36, wherein the roof is supported by lightweight supports and the roof is attached to a foundation through the use of micropiles.

39. The shelter according to claim 9, wherein the framework is hand assembled or mechanically assembled.

40. The shelter according to claim 9, wherein the framework is of a size to be self-contained in the structure.

41. The shelter according to claim 1, wherein the structure is an intermodal shipping container or an enclosure.

42. The shelter according to claim 41, wherein the enclosure is a molded enclosure.

43. The shelter according to claim 42, wherein the molded enclosure is made from one or more of aluminum, polyethylene, fiberglass, and combinations thereof.
